(19) United States
(12) Patent Application Publication
(10) Pub. No.: US 2021/0362299 A1
(43) Pub. Date: Nov. 25, 2021

(54) COMPOUND GRINDING WHEEL AND GRINDING DEVICE INCLUDING THE SAME

(71) Applicant: TOYOTA JIDOSHA KABUSHIKI KAISHA, Toyota-shi (JP)

(72) Inventor: Tomoya SUNAGA, Aichi-ken (JP)

(73) Assignee: TOYOTA JIDOSHA KABUSHIKI KAISHA, Toyota-shi (JP)

(21) Appl. No.: 17/182,445

(22) Filed: Feb. 23, 2021

(30) Foreign Application Priority Data
May 20, 2020 (JP) 2020-088230

(51) Int. Cl. B24D 5/06

(52) U.S. Cl. CPC B24D 5/06

(57) ABSTRACT

A compound grinding wheel includes a cylindrical elastic grinding wheel, a cylindrical vitrified grinding wheel, and a sleeve. The vitrified grinding wheel is arranged so as to be adjacent to the elastic grinding wheel, and has Young's modulus higher than Young's modulus of the elastic grinding wheel and an outer diameter that is the same as an outer diameter of the elastic grinding wheel. The sleeve is attached to an inner peripheral surface of the elastic grinding wheel, and has Young's modulus higher than the Young's modulus of the elastic grinding wheel. The vitrified grinding wheel is attached to the sleeve.

### CROSS-REFERENCE TO RELATED APPLICATION

This application claims priority to Japanese Patent Application No. 2020-088230 filed on May 20, 2020, incorporated herein by reference in its entirety.

### BACKGROUND

### 1. Technical Field

The present disclosure relates to a compound grinding wheel and a grinding device including the compound grinding wheel.

### 2. Description of Related Art

Japanese Unexamined Patent Application Publication No. 2019-181688 (JP 2019-181688 A) discloses a technique for generating and grinding a gear workpiece using a worm grinding wheel.

### SUMMARY

When an outer peripheral surface of the grinding wheel is brought into contact with a target workpiece to grind a surface of the target workpiece, there may be a case where a compound grinding wheel 100 as shown in FIG. 1 in which different types of grinding wheels are combined in an axial direction is used.

The compound grinding wheel 100 is typically configured in a manner such that a vitrified grinding wheel 101 and an elastic grinding wheel 102 are adhered to each other in an axial direction. FIG. 1 shows an adhesion region P between the vitrified grinding wheel 101 and the elastic grinding wheel 102. The vitrified grinding wheel 101 applies rough grinding and precision grinding to the surface to be processed, and the elastic grinding wheel 102 applies mirror finishing to the surface to be processed. The target workpiece is first brought into contact with the outer peripheral surface of the vitrified grinding wheel 101 and applied with rough grinding and precision grinding, and then is brought into contact with the outer peripheral surface of the elastic grinding wheel 102 and applied with mirror finishing. Combination of different types of grinding wheels makes it possible to achieve high productivity of grinding.

However, the Young's modulus of the elastic grinding wheel 102 is lower than the Young's modulus of the vitrified grinding wheel 101. Further, a density of the elastic grinding wheel 102 is smaller than a density of the vitrified grinding wheel 101. Therefore, as shown in FIG. 2, the elastic grinding wheel 102 is more apt to elongate larger (about 10 times) outward in a radial direction as compared with the vitrified grinding wheel 101 due to a centrifugal force generated as the compound grinding wheel 100 rotates. In the vitrified grinding wheel 101, a large tensile stress is generated outward in the radial direction due to the radially outward elongation of the elastic grinding wheel 102, as compared with the case where the vitrified grinding wheel 101 independently constitutes the grinding wheel.

As shown in FIG. 3, an upper limit is naturally specified for allowable tensile stress of the vitrified grinding wheel 101. When an attempt is made to strictly adhere to the upper limit, intentional reduction of a rotation speed of the compound grinding wheel 100 is required as compared with the case where the vitrified grinding wheel 101 independently constitutes the grinding wheel. In the example shown in FIG. 3, an allowable maximum rotation speed when the vitrified grinding wheel 101 independently constitutes the grinding wheel is n1, and an allowable maximum rotation speed of the compound grinding wheel 100 is n2. Note that, the rotation speed is regarded as a parameter that is directly related to productivity.

An object of the present disclosure is to provide a technique for increasing the allowable rotation speed of the compound grinding wheel in which grinding wheels having different Young's modulus are arranged and coupled in the axial direction.

An aspect of the present disclosure provides a compound grinding wheel including: a cylindrical first grinding wheel; a cylindrical second grinding wheel arranged so as to be adjacent to the first grinding wheel in an axial direction of the first grinding wheel, having Young's modulus that is higher than Young's modulus of the first grinding wheel, and having an outer diameter that is the same as an outer diameter of the first grinding wheel; and a sleeve attached to an inner peripheral surface of the first grinding wheel and having Young's modulus that is higher than the Young's modulus of the first grinding wheel. In the compound grinding wheel, the second grinding wheel is attached to the sleeve. With the above configuration, the allowable rotation speed of the compound grinding wheel in which grinding wheels having different Young's modulus are arranged and coupled in the axial direction is increased.

Preferably, an inner diameter of the sleeve is equal to an inner diameter of the second grinding wheel. With the above configuration, the inner peripheral surface of the compound grinding wheel becomes a straight surface in the axial direction.

Preferably, the second grinding wheel is attached to an axial end surface of the sleeve. With the above configuration, the compound grinding wheel can be easily manufactured.

Preferably, an axial dimension of the first grinding wheel is equal to an axial dimension of the sleeve. With the above configuration, the configuration of the compound grinding wheel is simplified.

Preferably, the sleeve includes a first sleeve portion arranged radially inward of the first grinding wheel and a second sleeve portion arranged radially inward of the second grinding wheel, an outer diameter of the first sleeve portion is larger than an outer diameter of the second sleeve portion, and an inner diameter of the first sleeve portion is equal to an inner diameter of the second sleeve portion. With to the above configuration, the sleeve having different diameters in the axial direction is realized.

Preferably, the second grinding wheel is attached to an outer peripheral surface of the second sleeve portion. With the above configuration, the compound grinding wheel can be easily manufactured.

Preferably, the Young's modulus of the sleeve is higher than Young's modulus of the second grinding wheel. With the above configuration, the tensile stress generated in the second grinding wheel is reduced.

Preferably, the first grinding wheel is an elastic grinding wheel.

Preferably, the second grinding wheel is a vitrified grinding wheel.

Preferably, the sleeve is adhered to the first grinding wheel.

Preferably, the sleeve is adhered to the second grinding wheel.

Preferably, a spiral groove for gear grinding is provided on an outer peripheral surface of the first grinding wheel and an outer peripheral surface of the second grinding wheel. With the above configuration, the compound grinding wheel can be used for gear grinding.

Preferably, a grinding device including the compound grinding wheel as described above is provided. With the above configuration, the grinding device having excellent productivity is realized.

According to the present disclosure, the allowable rotation speed of the compound grinding wheel in which grinding wheels having different Young's modulus are arranged and coupled in the axial direction is increased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a typical compound grinding wheel (comparative example);

FIG. 2 is a graph showing amounts of elongation of an elastic grinding wheel and a vitrified grinding wheel (comparative example);

FIG. 3 is a graph showing tensile stresses applied to the vitrified grinding wheel and the compound grinding wheel (comparative example);

FIG. 4 is a partially cutaway perspective view of the compound grinding wheel (first embodiment);

FIG. 5 is a cross-sectional view of a compound grinding wheel (first embodiment);

FIG. 6 is a graph showing amounts of elongation of an elastic grinding wheel, a vitrified grinding wheel, and a sleeve (first embodiment);

FIG. 7 is a graph showing the tensile stress applied to the compound grinding wheel (first embodiment);

FIG. 8 is a cross-sectional view of the elastic grinding wheel (second embodiment); and

FIG. 9 is a cross-sectional view of the elastic grinding wheel (third embodiment).

### DETAILED DESCRIPTION OF EMBODIMENTS

### First Embodiment

Hereinafter, a first embodiment will be described with reference to FIGS. 4 to 7.

As shown in FIG. 4, the compound grinding wheel 1 according to the first embodiment is a grinding wheel that has a cylindrical shape having a center line C and is used by rotating around the center line C. Specifically, a target workpiece is cut by rotating the compound grinding wheel 1 while bringing the target workpiece into contact with an outer peripheral surface of the compound grinding wheel 1.

The compound grinding wheel 1 includes an elastic grinding wheel 2 as a first grinding wheel, a vitrified grinding wheel 3 as a second grinding wheel, and a sleeve 4.

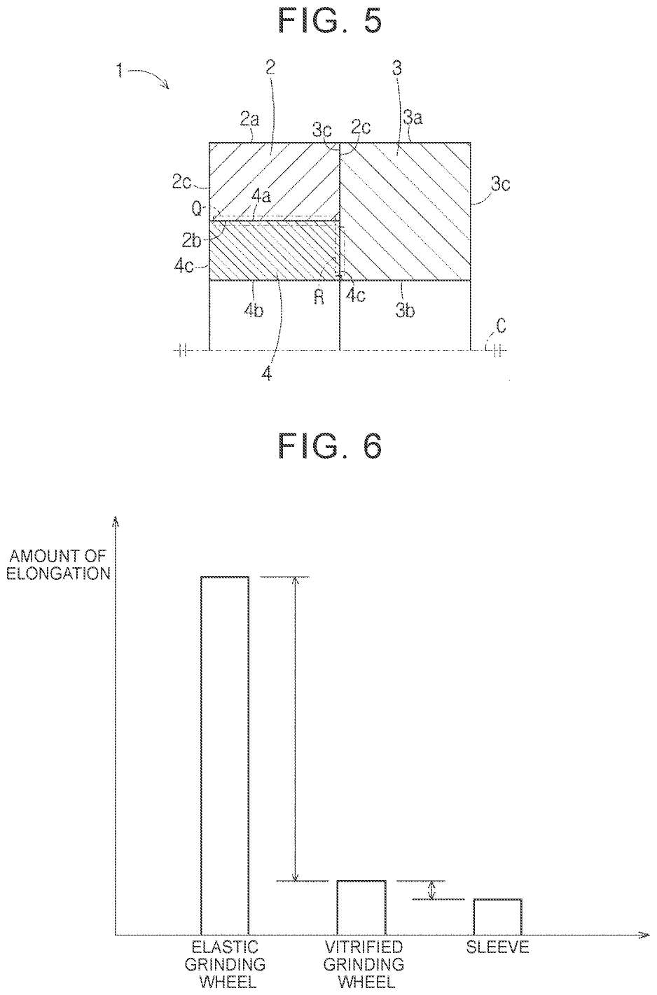

The elastic grinding wheel 2 is configured by bonding a large number of abrasive grains made of, for example, diamond, aluminum oxide, and silicon carbide, with a binder such as polyvinyl alcohol or polyurethane. The elastic grinding wheel 2 is a grinding wheel for applying mirror finishing to the target workpiece. As shown in FIG. 5, the elastic grinding wheel 2 includes an outer peripheral surface 2a and an inner peripheral surface 2b, and has a cylindrical shape with the center line C as the central axis. The elastic grinding wheel 2 further includes two axial end surfaces 2c. The two axial end surfaces 2c are end surfaces orthogonal to an axial direction of the compound grinding wheel 1. The Young's modulus of the elastic grinding wheel 2 is, for example, 200 MPa to 5000 MPa.

The vitrified grinding wheel 3 is arranged so as to be adjacent to the elastic grinding wheel 2 in an axial direction of the elastic grinding wheel 2. The vitrified grinding wheel 3 is obtained by bonding a large number of abrasive grains made of, for example, diamond, aluminum oxide, and silicon carbide, using vitrification as a binder. The vitrified grinding wheel 3 is a grinding wheel for rough grinding and precision grinding of the target workpiece. As shown in FIG. 5, the vitrified grinding wheel 3 includes an outer peripheral surface 3a and an inner peripheral surface 3b, and has a cylindrical shape with the center line C as the central axis. The vitrified grinding wheel 3 further includes two axial end surface 3c. The two axial end surface 3c are end surfaces orthogonal to the axial direction of the compound grinding wheel 1. The Young's modulus of the vitrified grinding wheel 3 is, for example, 20 GPa to 60 GPa.

The elastic grinding wheel 2 and the vitrified grinding wheel 3 are adjacent to each other in the axial direction of the compound grinding wheel 1. That is, one of the two axial end surfaces 2c of the elastic grinding wheel 2 and one of the two axial end surfaces 3c of the vitrified grinding wheel 3 are in surface contact with each other so as to face each other, but are not adhered to each other.

An outer diameter of the elastic grinding wheel 2 and the outer diameter of the vitrified grinding wheel 3 are preferably equal to each other in the no-load state of the compound grinding wheel 1, that is, in the state where the compound grinding wheel 1 is not rotating. The inner diameter of the elastic grinding wheel 2 is preferably larger than the inner diameter of the vitrified grinding wheel 3 in the no-load state of the compound grinding wheel 1, that is, in the state where the compound grinding wheel 1 is not rotating.

The sleeve 4 is attached to the inner peripheral surface 2b of the elastic grinding wheel 2. The sleeve 4 is made of, for example, aluminum or an aluminum alloy, and includes an outer peripheral surface 4a and an inner peripheral surface 4b. The sleeve 4 has a cylindrical shape with the center line C as the central axis. The sleeve 4 is typically adhered to the inner peripheral surface 2b of the elastic grinding wheel 2 with an adhesive. Specifically, the outer peripheral surface 4a of the sleeve 4 is adhered to the inner peripheral surface 2b of the elastic grinding wheel 2 with an adhesive. In FIG. 5, an adhesion region Q between the elastic grinding wheel 2 and the sleeve 4 is indicated by a chain double-dashed line. However, the sleeve 4 may be attached to the inner peripheral surface 2b of the elastic grinding wheel 2 by, for example, screw fastening or heat welding. The sleeve 4 further includes two axial end surfaces 4c. The two axial end surfaces 4c are end surfaces orthogonal to the axial direction of the compound grinding wheel 1. The Young's modulus of the sleeve 4 is preferably equal to or larger than the Young's modulus of the vitrified grinding wheel 3, and is, for example, 69 GPa to 76 GPa.

The vitrified grinding wheel 3 is attached to the sleeve 4. Specifically, one of the two axial end surfaces 3c of the vitrified grinding wheel 3 is attached to one of the two axial end surfaces 4c of the sleeve 4. One of the two axial end surfaces 3c of the vitrified grinding wheel 3 is typically adhered to one of the two axial end surfaces 4c of the sleeve 4 with an adhesive. In FIG. 5, an adhesion region R between the vitrified grinding wheel 3 and the sleeve 4 is indicated by a chain double-dashed line. However, the vitrified grinding wheel 3 may be attached to one of the two axial end surface 4c of the sleeve 4 by, for example, screw fastening or heat welding.

An outer diameter of the sleeve 4 is preferably larger than an inner diameter of the vitrified grinding wheel 3. An inner diameter of the sleeve 4 is preferably equal to the inner diameter of the vitrified grinding wheel 3.

An axial dimension of the sleeve 4 is preferably equal to an axial dimension of the elastic grinding wheel 2. Therefore, the inner peripheral surface 3b of the vitrified grinding wheel 3 is not covered by the sleeve 4 and is exposed inward in the radial direction.

The compound grinding wheel 1 according to the first embodiment is a screw-shaped grinding wheel for grinding continuously generated gears. Therefore, a spiral groove (not shown) for gear grinding is provided on the outer peripheral surface 2a of the elastic grinding wheel 2 and the outer peripheral surface 3a of the vitrified grinding wheel 3. However, the spiral groove may be omitted.

The above compound grinding wheel 1 is supplied to a grinding device 10 shown in FIG. 4. The grinding device 10 includes a rotary shaft 11, a motor 12 that rotationally drives the rotary shaft 11, and a frame (not shown) that supports the motor 12. The compound grinding wheel 1 is attached to the rotary shaft 11 in a manner such that the compound grinding wheel 1 is not rotatable.

With the above configuration, the target workpiece is first brought into contact with the outer peripheral surface 3a of the vitrified grinding wheel 3 in a state where the compound grinding wheel 1 is rotated at a desired rotation speed. With the processing above, rough grinding and precision grinding are applied to the target workpiece. Next, once the target workpiece is separated from the compound grinding wheel 1, and moved relative to the compound grinding wheel 1 in the axial direction. The target workpiece is then brought into contact with the outer peripheral surface 2a of the elastic grinding wheel 2. Consequently, mirror finishing is applied to the target workpiece.

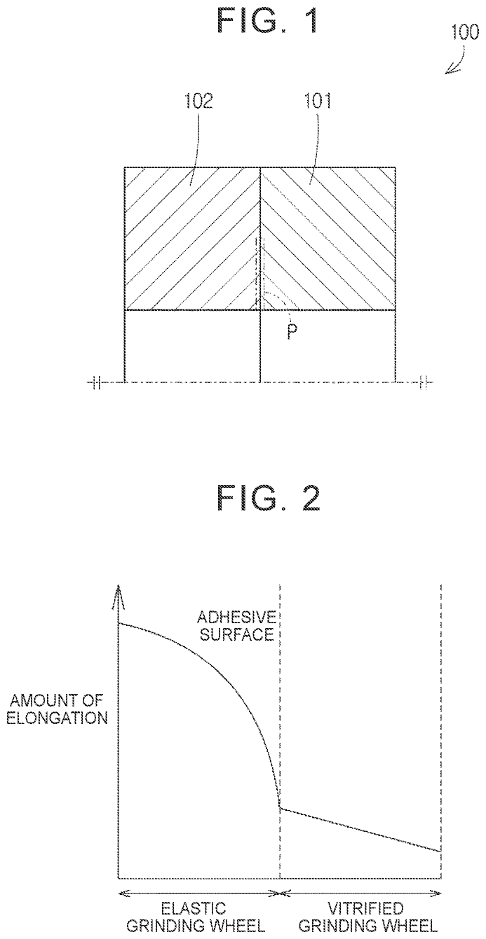

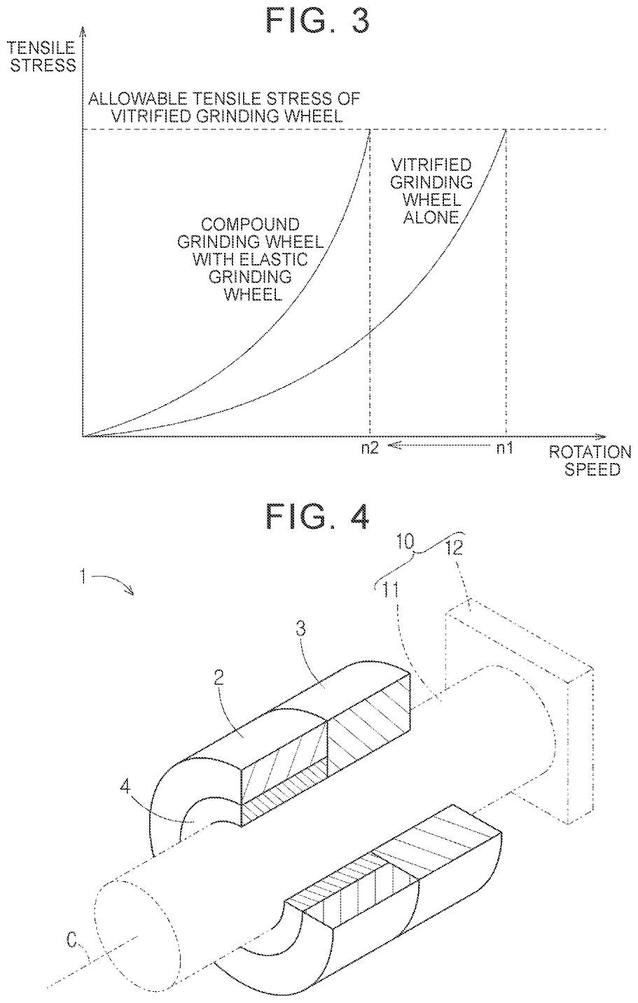

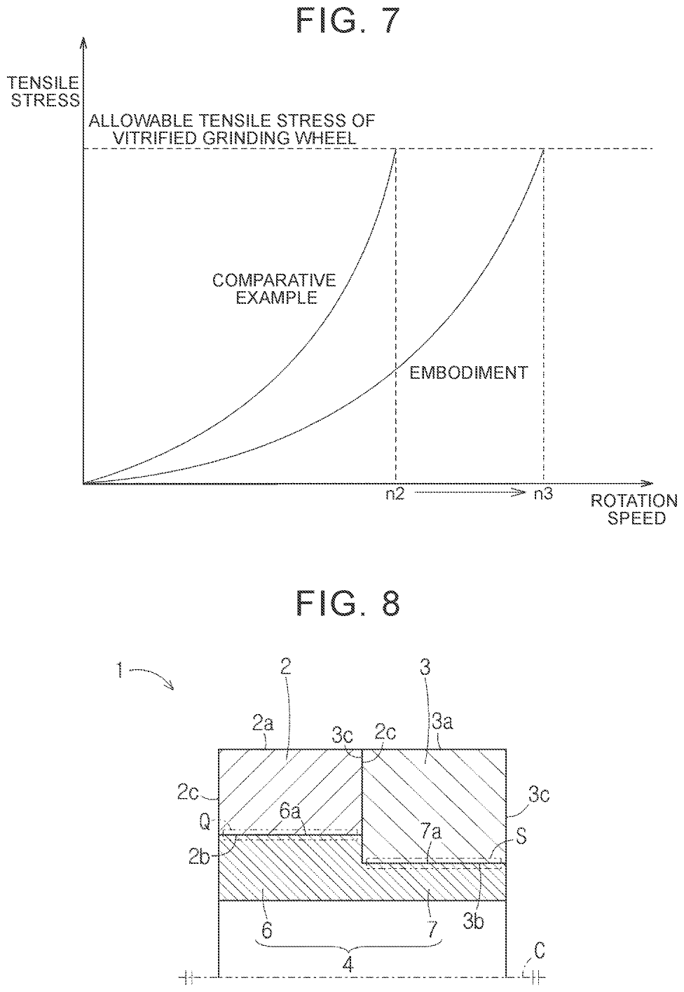

FIG. 6 shows the amounts of elongation of the elastic grinding wheel 102 and the vitrified grinding wheel 101 in the compound grinding wheel 100 shown in FIG. 1, and the amount of elongation of the sleeve 4 shown in FIG. 5. Each amount of elongation is an amount of elongation when each member is rotated at the same rotation speed. As shown in FIG. 6, a difference between the amount of elongation of the vitrified grinding wheel 3 and the amount of elongation of the sleeve 4 in the compound grinding wheel 1 according to the first embodiment is one-twentieth ( 1/20) of a difference between the amount of elongation of the vitrified grinding wheel 101 and the amount of elongation of the elastic grinding wheel 102 in the compound grinding wheel 100 of the comparative example shown in FIG. 1. Therefore, even when the rotation speed of the compound grinding wheel 1 is increased, the tensile stress of the vitrified grinding wheel 3 can be suppressed. Consequently, as shown in FIG. 7, the allowable rotation speed of the compound grinding wheel 1 can be increased 1.4 times (increased from n2 to n3), and productivity of the grinding using the compound grinding wheel 1 is improved.

The first embodiment has been described above. The first embodiment has the following features.

The compound grinding wheel 1 includes the cylindrical elastic grinding wheel 2 (first grinding wheel), and the cylindrical vitrified grinding wheel 3 (second grinding wheel), and the sleeve 4. The vitrified grinding wheel 3 is arranged so as to be adjacent to the elastic grinding wheel 2, and has the Young's modulus higher than the Young's modulus of the elastic grinding wheel 2 and the outer diameter that is the same as the outer diameter of the elastic grinding wheel 2. The sleeve 4 is attached to the inner peripheral surface 2b of the elastic grinding wheel 2 and has the Young's modulus higher than the Young's modulus of the elastic grinding wheel 2. The vitrified grinding wheel 3 is attached to the sleeve 4. With the above configuration, even when the vitrified grinding wheel is combined with the elastic grinding wheel to constitute the compound grinding wheel, the tensile stress newly generated in the vitrified grinding wheel is suppressed, which can increase the allowable rotation speed of the compound grinding wheel.

The inner diameter of the sleeve 4 is equal to the inner diameter of the vitrified grinding wheel 3. With the above configuration, the inner peripheral surface of the compound grinding wheel 1 becomes a straight surface in the axial direction.

Further, the vitrified grinding wheel 3 is attached to the axial end surface 4c of the sleeve 4. With the above configuration, the compound grinding wheel 1 can be easily manufactured.

Further, the axial dimension of the elastic grinding wheel 2 is equal to the axial dimension of the sleeve 4. With the above configuration, the configuration of the compound grinding wheel 1 is simplified.

Further, the Young's modulus of the sleeve 4 is higher than the Young's modulus of the vitrified grinding wheel 3. With the above configuration, the tensile stress generated in the vitrified grinding wheel 3 can be suppressed.

Further, the elastic grinding wheel 2 is an elastic grinding wheel.

Further, the vitrified grinding wheel 3 is a vitrified grinding wheel.

Further, the sleeve 4 is adhered to the elastic grinding wheel 2.

Further, the sleeve 4 is adhered to the vitrified grinding wheel 3.

Therefore, the spiral groove for gear grinding is provided on the outer peripheral surface 2a of the elastic grinding wheel 2 and the outer peripheral surface 3a of the vitrified grinding wheel 3. With the above configuration, the compound grinding wheel 1 can be used for gear grinding.

Further, the grinding device 10 provided with the compound grinding wheel 1 above is provided. With the above configuration, the grinding device 10 having excellent productivity is realized.

A distance from the inner peripheral surface 2b of the elastic grinding wheel 2 to the center line C can be set based on the inner diameter of the compound grinding wheel 1 and amounts of deformation of the elastic grinding wheel 2, the vitrified grinding wheel 3, and the sleeve 4. Specifically, the distance from the inner peripheral surface 2b of the elastic grinding wheel 2 to the center line C is set such that the amount of radially outward displacement of the outer peripheral surface 4a of the sleeve 4 when the compound grinding wheel 1 is rotated becomes equal to the amount of radially outward displacement of a portion of the vitrified grinding wheel 3 that corresponds to the outer peripheral surface 4a of the sleeve 4. Here, each of the amounts of displacement can be calculated based on the radius, the Young's modulus, and the density of each member. With the above settings, when the compound grinding wheel 1 is rotated, the sleeve 4 and the vitrified grinding wheel 3 are deformed outward in the radial direction to the same extent. Therefore, no external force other than the centrifugal force is generated on the vitrified grinding wheel 3.

### Second Embodiment

Hereinafter, a second embodiment will be described with reference to FIG. 8. Hereinafter, different points of the second embodiment from the first embodiment will be mainly described, and duplicate descriptions will be omitted.

In the second embodiment, the sleeve 4 includes a first sleeve portion 6 arranged radially inward of the elastic grinding wheel 2 and a second sleeve portion 7 arranged radially inward of the vitrified grinding wheel 3.

An outer diameter of the first sleeve portion 6 is larger than an outer diameter of the second sleeve portion 7. That is, the inner diameter of the elastic grinding wheel 2 is larger than the inner diameter of the vitrified grinding wheel 3.

An inner diameter of the first sleeve portion 6 is equal to an inner diameter of the second sleeve portion 7.

Therefore, the sleeve 4 is a variable diameter sleeve having outer diameter that is variable in the axial direction of the compound grinding wheel 1. In other words, the sleeve 4 having different diameters in the axial direction of the compound grinding wheel 1 is realized.

The axial dimension of the second sleeve portion 7 is equal to the axial dimension of the vitrified grinding wheel 3. Therefore, the entire inner peripheral surface 3b of the vitrified grinding wheel 3 is covered by the second sleeve portion 7, and any portion of the inner peripheral surface 3b is not exposed radially inward.

The elastic grinding wheel 2 is adhered to an outer peripheral surface 6a of the first sleeve portion 6 with an adhesive. In FIG. 8, an adhesion region Q between the elastic grinding wheel 2 and the first sleeve portion 6 of the sleeve 4 is shown by a chain double-dashed line. Further, the vitrified grinding wheel 3 is adhered to an outer peripheral surface 7a of the second sleeve portion 7 with an adhesive. In FIG. 8, an adhesion region S between the vitrified grinding wheel 3 and the second sleeve portion 7 of the sleeve 4 is shown by a chain double-dashed line. With the above configuration, the compound grinding wheel 1 can be easily manufactured.

### Third Embodiment

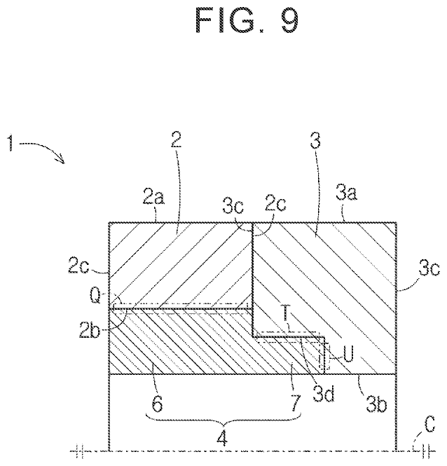

Hereinafter, a third embodiment will be described with reference to FIG. 9. Hereinafter, different points of the third embodiment from the second embodiment above will be mainly described, and duplicate descriptions will be omitted.

In the third embodiment, the second sleeve portion 7 is arranged radially inward of the vitrified grinding wheel 3 as in the second embodiment.

In the second embodiment, an axial dimension of the second sleeve portion 7 is equal to the axial dimension of the vitrified grinding wheel 3. Therefore, the entire inner peripheral surface 3b of the vitrified grinding wheel 3 is covered by the second sleeve portion 7, and any portion of the inner peripheral surface 3b is not exposed radially inward.

According to the third embodiment, the axial dimension of the second sleeve portion 7 is smaller than the axial dimension of the vitrified grinding wheel 3. A recess 3d that is recessed outward in the radial direction is provided on the inner peripheral surface 3b of the vitrified grinding wheel 3 at a position closer to the elastic grinding wheel 2. The second sleeve portion 7 of the sleeve 4 is housed in the recess 3d of the vitrified grinding wheel 3. The second sleeve portion 7 of the sleeve 4 is adhered to an inner surface of the recess 3d of the vitrified grinding wheel 3 with an adhesive. In FIG. 9, an adhesion region T and an adhesion region U between the second sleeve portion 7 and the vitrified grinding wheel 3 are shown by a chain double-dashed line.

With the above configuration, the entire inner peripheral surface 3b of the vitrified grinding wheel 3 is not covered by the second sleeve portion 7. Therefore, the inner peripheral surface 3b of the vitrified grinding wheel 3 can be partially exposed inward in the radial direction.

What is claimed is:

1. A compound grinding wheel, comprising:
a cylindrical first grinding wheel;
a cylindrical second grinding wheel arranged so as to be adjacent to the first grinding wheel in an axial direction of the first grinding wheel, having Young's modulus that is higher than Young's modulus of the first grinding wheel, and having an outer diameter that is the same as an outer diameter of the first grinding wheel; and
a sleeve attached to an inner peripheral surface of the first grinding wheel and having Young's modulus that is higher than the Young's modulus of the first grinding wheel, wherein the second grinding wheel is attached to the sleeve.

2. The compound grinding wheel according to claim 1, wherein an inner diameter of the sleeve is equal to an inner diameter of the second grinding wheel.

3. The compound grinding wheel according to claim 2, wherein the second grinding wheel is attached to an axial end surface of the sleeve.

4. The compound grinding wheel according to claim 2, wherein an axial dimension of the first grinding wheel is equal to an axial dimension of the sleeve.

5. The compound grinding wheel according to claim 1, wherein:
the sleeve includes a first sleeve portion arranged radially inward of the first grinding wheel and a second sleeve portion arranged radially inward of the second grinding wheel;
an outer diameter of the first sleeve portion is larger than an outer diameter of the second sleeve portion; and
an inner diameter of the first sleeve portion is equal to an inner diameter of the second sleeve portion.

6. The compound grinding wheel according to claim 5, wherein the second grinding wheel is attached to an outer peripheral surface of the second sleeve portion.

7. The compound grinding wheel according to claim 1, wherein the Young's modulus of the sleeve is higher than Young's modulus of the second grinding wheel.

8. The compound grinding wheel according to claim 1, wherein the first grinding wheel is an elastic grinding wheel.

9. The compound grinding wheel according to claim 1, wherein the second grinding wheel is a vitrified grinding wheel.

10. The compound grinding wheel according to claim 1, wherein the sleeve is adhered to the first grinding wheel.

11. The compound grinding wheel according to claim 1, wherein the sleeve is adhered to the second grinding wheel.

12. The compound grinding wheel according to claim 1, wherein a spiral groove for gear grinding is provided on an outer peripheral surface of the first grinding wheel and an outer peripheral surface of the second grinding wheel.

13. A grinding device including the compound grinding wheel according to claim 1.
